(19) United States
(12) Patent Application Publication
(10) Pub. No.: US 2016/0336610 A1
(43) Pub. Date: Nov. 17, 2016

(54) METHOD FOR ADJUSTING AN OPERATING GAS FLOW IN A FUEL CELL SYSTEM, AND A FUEL CELL SYSTEM

(71) Applicant: Volkswagen AG, Wolfsburg (DE)

(72) Inventors: Pater Bach, Burnaby (CA); Samuel Yew, Burnaby (CA)

(21) Appl. No.: 15/148,583

(22) Filed: May 6, 2016

(30) Foreign Application Priority Data
May 13, 2015 (DE) DE102015208920.7

(51) Int. Cl. H01M 8/04746; H01M 8/0438; H01M 8/0432; H01M 8/04089

(52) U.S. Cl. CPC H01M 8/04753; H01M 8/04097; H01M 8/04395; H01M 8/04328; H01M 8/04388; H01M 8/04335

(57) ABSTRACT

A method for adjusting an operating gas flow in a fuel cell system including a fuel cell stack, a supply path for feeding operating gas to the fuel cell stack, an exhaust gas path for removing the operating gas from the fuel cell stack, as well as a recirculation line, including a conveyor unit, which connects the supply path and the exhaust gas path to each other. The method includes measuring a pressure p₁ and a temperature T₁ in the supply path upstream from a junction point between the recirculation line and the supply path; measuring a pressure p₂ and a temperature T₂ in the recirculation line upstream from the junction point; measuring a pressure p₃ and a temperature T₃ in the supply path downstream from the junction point; determining a recirculation ratio from the parameters T₁, T₂, T₃, p₁, p₂ and p₃; adjusting the operating gas flow through the recirculation line as a function of the recirculation ratio.

This claims the benefit of German Patent Application DE 102015208920.7, filed May 13, 2015 and hereby incorporated by reference herein.

The present invention relates to a method for adjusting an operating gas flow in a fuel cell system, as well as a fuel cell system for carrying out the method.

### BACKGROUND

Fuel cell stacks produce electrical energy through the reaction between fuel (for example, hydrogen) from a storage device or a supply network and oxygen, for example from ambient air. Oxygen is supplied to the stack on a cathode side, and fuel is supplied to the stack on an anode side.

Fuel cells use the chemical conversion of a fuel to water with the aid of oxygen to generate electrical energy. For this purpose, fuel cells include the so-called membrane electrode assembly (MEA) as a core component, which is an assembly of an ion-conducting, in particular proton-conducting, membrane and an electrode (anode and cathode) situated on both sides of the membrane. In addition, gas diffusion layers (GDL) may be situated on both sides of the membrane electrode assembly, on the sides of the electrodes facing away from the membrane. The fuel cell is generally formed by a large number of MEAs situated in a stack, whose electrical powers add up. During the operation of the fuel cell, the fuel, in particular hydrogen H₂ or a hydrogen-containing gas mixture, is supplied to the anode, where an electrochemical oxidation of H₂ to H⁺ takes place with the discharge of electrons. A (water-bound or water-free) transfer of protons H⁺ from the anode space into the cathode space takes place via the electrolyte or the membrane, which separates and electrically insulates the reaction spaces from each other in a gas-tight manner. The electrons provided at the anode are supplied to the cathode via an electric line. An oxygen or an oxygenated gas mixture is supplied to the cathode, so that a reduction from O₂ to O²⁻ takes place with the absorption of the electrons. At the same time, in the cathode space, these oxygen anions react with the protons transferred via the membrane, forming water. By directly converting chemical energy into electrical energy, fuel cells achieve an improved efficiency, compared to other electricity generators, due to their circumvention of the Carnot factor.

The membrane electrode assemblies are semipermeable and enable, among other things, nitrogen and water vapor to diffuse from the cathode side to the anode side. This nitrogen transfer results in a dilution of the anode operating gas in the anode exhaust gas path. If the nitrogen concentration increases above a certain percentage, the efficiency of the fuel cell decreases.

An attempt is made to maintain an essentially constant fuel distribution in the anode flow channels in the fuel cell stack to ensure proper operation of the fuel cell stack. More fuel is therefore conventionally supplied to the fuel cell stack than is calculationally necessary for a certain output load of the stack to achieve a uniform anode gas distribution.

Since the anode reaction is usually carried out with the aid of a hyperstoichiometric metering of the fuel, a complete reaction of the total fuel supplied does not take place in the fuel cell stack. Nor does a complete reaction of the oxygen occur. To use the fuel efficiently, the latter is therefore frequently conducted (recirculated) in a circuit via a recirculation line, so that, before feeding the fuel back to the fuel cell stack, the fuel is enriched to the extent that a hyperstoichiometric metering of the fuel is again present, and the reaction may take place.

To operate the fuel cell stack under optimized conditions and to maximize the system performance, a defined recirculation rate should be achieved in addition to a hyperstoichiometric quantity of fuel in the anode supply system. The recirculation rate is a measure of the number of times the operating gas passes through the recirculation line. To determine the recirculation rate, the flow of fuel through the recirculation line would have to be determined. Up to now, however, no concentration sensors are known which are suitable for common fuels, in particular hydrogen, nor are flow sensors available, which are reliable under the damp conditions in the fuel cell system.

If the fuel is present under pressure for the purpose of enrichment, it may be provided for enrichment with the aid of a driving nozzle, so that the driving nozzle also causes the circuit to be driven and the remaining fuel to be recirculated. One example of a fuel cell system including a driving nozzle is disclosed in the publication EP 1421639 B1. Another option for recirculating the remaining fuel is to use electromotively driven blowers, so-called HRBs.

It is therefore not possible to control the operating gas flow directly. One approach to solving this problem is a method disclosed in DE 10 2009 019 838 B4 for calculating the recirculation rate, which correlates the pressures of the anode operating gas in different areas of the anode supply system.

### SUMMARY OF THE INVENTION

The pressure of the operating gas is dependent on additional factors, in particular the temperature and the fuel concentration, which vary within the anode supply system and are additionally heavily influenced by the described nitrogen transfer. This makes the calculation models known from the prior art highly susceptible to errors. Due to the complex structure of the known models, even minor errors result in high discrepancies between the calculated and the actual recirculation rate.

It is an object of the present of the present invention to provide a method for adjusting an operating gas flow which aids overcoming the problems of the prior art. For example, the operating gas flow preferably should be able to reliably follow the varying parameters with little complexity.

The present invention provides a method for adjusting an operating gas flow in a fuel cell system. The fuel cell system includes a fuel cell stack, a supply path for feeding operating gas to the fuel cell stack, an exhaust gas path for removing the operating gas from the fuel cell stack, as well as a recirculation line, including a conveyor unit for conveying the operating gas flow, which connect the supply path and the exhaust gas path to each other. According to the present invention, the method includes the following steps:

measuring a pressure p₁ and a temperature T₁ in the supply path upstream from a junction point between the recirculation line and the supply path;

measuring a pressure p₂ and a temperature T₂ in the recirculation line upstream from the junction point;

measuring a pressure p₃ and a temperature T₃ in the supply path downstream from the junction point;

determining a recirculation ratio (x) as a function of parameters T₁, T₂, T₃, p₁, p₂ and p₃; and

adjusting the operating gas flow, in particular a recirculation rate, through the recirculation line as a function of the recirculation ratio (x).

The method according to the present invention has the advantage, among other things, that it not only adjusts the operating gas flow on a one-time basis but also determines the demand of the fuel cell stack for the relevant operating gas at different positions in the supply path as a function of the operating variables of temperature and pressure and subsequently regulates the operating gas flow. The efficiency of the fuel cell system may thus be increased, and the absolute quantity of operating gas may simultaneously be reduced.

The method according to the present invention is characterized, in particular, in that both the pressures and the temperatures measured in the system are included in the determination. This makes it possible to take into account a change in the concentration of the operating gas in the exhaust gas flow and/or in the recirculation line. Moreover, changes in the recirculation rate, which are attributable to aging processes of the fuel cell stack, such as a fuel leak, may be made accessible and included in the determination of the recirculation rate. The operating gas flow is then adjusted, in particular readjusted, taking all these parameters into account. This increases the power stability of the fuel cell stack as well as the efficiency of the fuel cell system.

It is also advantageous that the sensors used to determine the temperatures and the pressures are extremely reliable, highly developed and economical, compared to flowmeter devices.

In the method according to the present invention, the power of the conveying means and the operating gas concentration are advantageously only indirectly included in the determination of the recirculation rate. A complex measurement of these variables may thus be dispensed with.

In the present case, the recirculation rate is a flow rate and is thus proportionate to the quantity of the operation gas flowing through the recirculation line per time unit. Recirculation ratio, in turn, is understood to be the ratio between the recirculation rate and a total flow rate, i.e., the flow rate in the supply path, in particular downstream from the junction point.

The junction point is the position in the supply line where the recirculation line merges with the supply path, i.e., where an inflow of fresh operating gas mixes with an inflow of recycled exhaust gas.

Pressures p1, p2, and p3 are measured with the aid of conventional pressure sensors, and temperatures T1, T2 and T3 are similarly measured with the aid of conventional temperature sensors. The particular corresponding sensors, i.e., for example the pressure sensor for measuring p1 and the temperature sensor for measuring T1, are situated at a preferably short distance from each other. The measuring points preferably coincide, for example when using dual sensors.

To reduce errors, the pressures and temperatures are preferably measured simultaneously. The measured data are transmitted to a control unit, in which an algorithm is stored for determining the recirculation ratio (x), using the measured data. Based on this recirculation ratio (x), the control unit determines the optimum recirculation rate (r) for the instantaneous operating state of the fuel cell system, with the aid of another algorithm and possibly using stored constants, and transmits a corresponding control signal to an actuator. If necessary, a change in variables is triggered with the aid of the actuator, thus adapting the recirculation rate.

In one preferred embodiment of the present invention, the recirculation ratio (x) is determined as a function of the products of the corresponding parameters, i.e., as a function of (T₁·p₁), (T₂·p₂) and (T₃·p₃), in particular a ratio of the products to each other, since they at least indirectly represent a good relationship for the flow rate. The differences between the measuring points in the supply path downstream and upstream from the junction point ((T₃·p₃)−(T₁·p₁)), as well as the measuring points in the recirculation line and in the supply path upstream from the junction point ((T₂·p₂)−(T₁·p₁)) are preferably correlated with each other. It is thus particularly preferable that the recirculation ratio (x) is determined according to the following equation, y preferably being a fraction, in particular in the range between 1.3 and 1.5.

$$x = \frac{{T}_{3} {P}_{3}^{\frac{1 - γ}{γ}} - {T}_{1} {P}_{1}^{\frac{1 - γ}{γ}}}{{T}_{2} {P}_{2}^{\frac{1 - γ}{γ}} - {T}_{1} {P}_{1}^{\frac{1 - γ}{γ}}}$$

In another preferred embodiment of the present invention, the conveyor unit is situated in the recirculation line in the area of the junction point. In other words, the section of the recirculation line between the junction point and the conveyor unit is preferably as short as possible. In particular, the position of the conveyor unit and that of the junction point preferably coincide. The conveyor unit is, for example, a passive drive, such as a jet pump or a driving nozzle, in which the operating gas flow is aspirated from the recirculation line, due to the operating gas flowing through the supply line. Alternatively, active blowers, i.e. operated by an external power supply, such as HRBs, are used to drive the operating gas flow.

T₂ and p₂ are particularly advantageously measured upstream from the conveyor unit, in particular when the position of the conveyor unit does not coincide with the junction point. The advantage of this embodiment lies in a higher accuracy of the calculated and actual recirculation rates.

Since the fuel is often much more expensive than the oxidizing agent (e.g., air) and is a determining factor in efficiency, the method is preferably used in the anode supply system so that the operating gas is preferably fuel, in particular hydrogen.

The operating gas flow, in particular the recirculation rate, may be adjusted or regulated at different positions in the operating gas supply system. According to one preferred embodiment, the operating gas flow is thus adjusted by varying an actuating means of the conveyor unit, with the aid of an actuating means in the exhaust gas path, an actuating means in the recirculation line, in particular upstream from the conveyor unit, or with the aid of an actuating means in the supply path.

Alternatively, the operating gas flow is adjusted by varying pressure p₁ in the supply path. This option suggests itself, in particular when using jet pumps as the conveyor unit.

Another aspect of the present invention relates to a fuel cell system, which is configured to carry out the method according to the present invention. A fuel cell system of this type includes, in particular, a control unit, in which an algorithm is stored for calculating the recirculation rate according to the method according to the present invention. The fuel cell system according to the present invention furthermore includes lines for transmitting control signals from temperature and/or pressure sensors to actuators for the purpose of regulating the recirculation rate.

The different specific embodiments of the present invention mentioned in this application may be advantageously combined with each other unless otherwise indicated in the individual case.

### BRIEF DESCRIPTION OF THE DRAWINGS

The present invention is explained below in exemplary embodiments on the basis of the corresponding drawings.

FIG. 1 shows a schematic representation of a fuel cell system according to one preferred embodiment of the present invention; and

FIG. 2 shows a schematic representation of an anode supply system as a detail of the fuel cell system according to the present invention in the preferred embodiment of the present invention.

### DETAILED DESCRIPTION

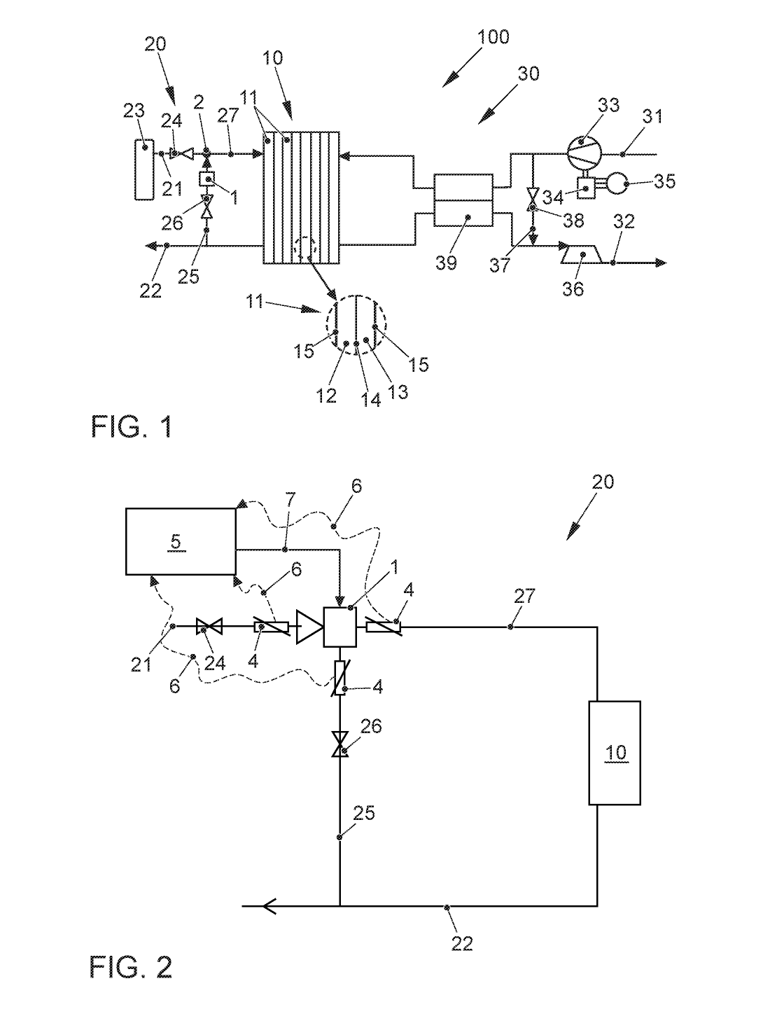

FIG. 1 shows a fuel cell system which is designated as a whole by reference numeral 100, according to one preferred embodiment of the present invention. Fuel cell system 100 is part of a vehicle, in particular an electric vehicle, which includes an electric traction motor, which is supplied with electrical energy by fuel cell system 100.

Fuel cell system 100 includes a fuel cell stack 10 as a key component, which has a large number of individual cells 11 arranged in the form of a stack. Each individual cell 11 includes an anode space 12 as well as a cathode space 13, which are separated from each other by an ion-conductive polymer electrolyte membrane 14 (see detail). The anode and cathode spaces 12, 13 each include a catalytic electrode, the anode or the cathode, which catalyzes the particular partial reaction of the fuel cell conversion. The anode and cathode electrodes include a catalytic material, for example platinum, which is supported on an electrically conductive carrier material having a large specific surface, for example a carbon-based material. A bipolar plate, which is indicated by reference numeral 15, is furthermore situated between two membrane electrode assemblies of this type, which is used to supply the operating media into anode and cathode spaces 12, 13 and which also establishes the electrical connection between individual fuel cells 11.

To supply fuel cell stack 10 with the operating gases, fuel cell system 100 includes an anode supply system 20, on the one hand, and a cathode supply system 30, on the other hand.

Anode supply system 20 includes an anode supply path 21, which is used for supplying an anode operating medium (the fuel), for example hydrogen, to anode spaces 12 of fuel cell stack 10. For this purpose, anode supply path 21 connects a fuel storage unit 23 to an anode inlet of fuel cell stack 10. Anode supply system 20 furthermore includes an anode exhaust gas path 22, which removes the anode exhaust gas from anode spaces 12 via an anode outlet of fuel cell stack 10. The anode operating pressure on anode sides 12 of fuel cell stack 10 is adjustable with the aid of an actuator 24 in anode supply path 21. Moreover, anode supply system 20 may include a fuel cell recirculation line 25, as illustrated, which connects anode exhaust gas path 22 to anode supply path 21 and empties into anode supply path 21 at junction point 2. The recirculation of fuel is common practice for the purpose of feeding the usually hyperstoichiometrically used fuel back to the stack and using it there. A conveyor unit 1 for fuel, as well as another actuator 26, with the aid of which the recirculation rate is adjustable, is situated in fuel recirculation line 25.

Cathode supply system 30 includes a cathode supply path 31, which supplies cathode spaces 13 of fuel cell stack 10 with an oxygenated cathode operating medium, in particular air, which is aspirated from the surroundings. Cathode supply system 30 furthermore includes a cathode exhaust gas path 32, which removes the cathode exhaust gas (in particular the exhaust air) from cathode spaces 13 of fuel cell stack 10 and, if necessary, feeds it to an exhaust gas system, which is not illustrated.

A compressor 33 is situated in cathode supply path 31 for the purpose of conveying and compressing the cathode operating medium. In the illustrated exemplary embodiment, compressor 33 is designed as a primarily electromotively driven compressor, whose driving action takes place via an electric motor 35 equipped with corresponding power electronics 36. Compressor 33 may furthermore be driven in a supporting manner by a turbine 40 situated in cathode exhaust gas path 32 via a shared shaft. Turbine 40 represents an expander which effectuates an expansion of the cathode exhaust gas and thus a reduction of its pressure.

According to the illustrated exemplary embodiment, cathode supply system 30 furthermore includes a wastegate line 37, which connects cathode supply line 31 to cathode exhaust gas line 32, and therefore forms a bypass of fuel cell stack 10. Wastegate line 37 makes it possible to temporarily reduce the operating pressure of the cathode operating medium in fuel cell stack 10, without shutting down compressor 33. An actuator 38 situated in wastegate line 37 allows the quantity of the cathode operating medium circumventing fuel cell stack 10 to be controlled. All actuators 24, 26, 38 of fuel cell system 100 may be designed as controllable or non-controllable valves or flaps. Other corresponding actuators may be situated in lines 21, 22, 31 and 32 for the purpose of isolating fuel cell stack 10 from the surroundings.

Fuel cell system 100 furthermore includes a membrane humidifier 39. Membrane humidifier 39 is situated in cathode supply path 31 in such a way that cathode operating gas may flow through it. It is also situated in cathode exhaust gas path 32 in such a way that cathode exhaust gas may flow through it. Membrane humidifier 39 typically includes a plurality of water vapor-permeable membranes, which are designed to be either planar or in the form of hollow fibers. The comparatively dry cathode operating gas (air) flows over one side of the membranes, and the comparatively damp cathode exhaust gas (exhaust gas) flows over the other side. Driven by the elevated partial pressure of water vapor in the cathode exhaust gas, the water vapor passes over the membrane into the cathode operating gas, which is humidified in this way.

Various other details of anode and cathode supplies systems 20, 30 are simplified FIG. 1 for reasons of clarity. Thus, a water separator may be installed in anode and/or cathode exhaust gas path 22, 32 to condense and discharge the product water resulting from the fuel cell reaction. Finally, anode exhaust gas line 22 may empty into cathode exhaust gas line 32, so that the anode exhaust gas and the cathode exhaust gas may be discharged via a shared exhaust gas system.

The part of fuel cell system 100 essential to the present invention is shown in detail in FIG. 2, based on the example of an anode supply system 20. In this specific embodiment, conveyor unit 1 is designed as a jet pump and situated at junction point 21. Alternatively or additionally, conveyor unit 1 may be designed as a blower, in particular an HRB (hydrogen recirculation blower) and/or be situated in recirculation line 25, upstream from junction point 2. Sensors 4 for measuring pressure and temperature are situated in anode supply system 20, which may be both combined temperature/pressure sensors and separate sensors 4. Sensors 4 of this type are situated in at least three positions in anode supply system 20, namely in the anode supply path, downstream and upstream from junction point 2, as well as in recirculation line 25, upstream from junction point 2.

FIG. 2 describes an operating system 100 according to the present invention only by way of example, based on an anode supply system 20, and may be analogously applied to a cathode supply system 30.

Fuel cell system 100 illustrated in FIGS. 1 and 2 is suitable for carrying out the method according to the present invention. The temperature and the pressure are measured in the supply path continuously, as needed or at defined intervals with the aid of sensors 4. The measured values are transmitted to control unit 5 with the aid of control signals 6. The recirculation rate is determined in the control unit with the aid of the algorithm according to the present invention, by determining the recirculation ratio. If the actual value deviates from a defined setpoint value, a control signal 7 is sent to an actuator in the system. The latter may be conveyor unit 1 itself, as illustrated. Alternatively or additionally, the recirculation rate may be adjusted via actuating means 24 and 26, the latter receiving a corresponding control signal 7.

It has been found that, during ongoing operation, a minimum recirculation rate to be maintained may be defined as the setpoint variable by monitoring temperature parameters T₃ and T₂ and, in particular, by ascertaining a difference T₃−T₂. The minimum recirculation rate to be maintained is preferably always greater than the difference (T₃−T₂).

### LIST OF REFERENCE NUMERALS

100 fuel cell system
1 conveyor unit
2 junction point
4 sensor
5 control unit
6,7 control signal
10 fuel cell stack
11 individual cell
12 anode space
13 cathode space
14 polymer electrolyte membrane
15 bipolar plate
20 anode supply system
21 anode supply path upstream from the junction point
22 anode exhaust gas path
23 fuel tank
24 actuating means
25 fuel recirculation line
26 actuating means
27 anode supply path downstream from the junction point
30 cathode supply system
31 cathode supply path
32 cathode exhaust gas path
33 compressor
34 electric motor
35 power electronics
36 turbine
37 wastegate line
38 actuating means
39 membrane humidifier

What is claimed is:

1. A method for adjusting an operating gas flow in a fuel cell system, the fuel cell system including a fuel cell stack, a supply path for feeding operating gas to the fuel cell stack, an exhaust gas path for removing the operating gas from the fuel cell stack, as well as a recirculation line, including a conveyor for conveying flow of the operating gas, the recirculation line connecting the supply path and the exhaust gas path to each other, the method comprising the following steps:
measuring a pressure p₁ and a temperature T₁ in the supply path upstream from a junction point between the recirculation line and the supply path;
measuring a pressure p₂ and a temperature T₂ in the recirculation line upstream from the junction point;
measuring a pressure p₃ and a temperature T₃ in the supply path downstream from the junction point;
determining a recirculation ratio as a function of parameters T₁, T₂, T₃, p₁, p₂ and p₃; and
adjusting the operating gas flow through the recirculation line as a function of the recirculation ratio.

2. The method as recited in claim 1 wherein the recirculation ratio is determined as a function of the products (T₁·p₁), (T₂·p₂) and (T₃·p₃).

3. The method as recited in claim 1 wherein the recirculation ratio is determined according to
$$x = \frac{{T}_{3} {P}_{3}^{\frac{1 - γ}{γ}} - {T}_{1} {P}_{1}^{\frac{1 - γ}{γ}}}{{T}_{2} {P}_{2}^{\frac{1 - γ}{γ}} - {T}_{1} {P}_{1}^{\frac{1 - γ}{γ}}} .$$

4. The method as recited in claim 1 wherein the conveyor unit is situated in the recirculation line in the area of the junction point.

5. The method as recited in claim 1 wherein T₂ and p₂ are measured upstream from the conveyor unit.

6. The method as recited in claim 1 wherein the operating gas is an anode gas.

7. The method as recited in claim 6 wherein the anode gas is hydrogen.

8. The method as recited in claim 1 wherein the operating gas flow is adjusted with the aid of an actuator in the recirculation line and with the aid of a further actuator in the exhaust gas path or in the supply path.

9. The method as recited in claim 8 wherein the actuator is upstream of the conveyor.

10. The method as recited in claim 1 wherein the operating gas flow is adjusted by varying the pressure p₁ in the supply path.

11. A fuel cell system comprising:
a fuel cell stack, a supply path for feeding operating gas to the fuel cell stack, an exhaust gas path for removing the operating gas from the fuel cell stack, as well as a recirculation line, including a conveyor for conveying flow of the operating gas, the recirculation line connecting the supply path and the exhaust gas path to each other, the fuel cell system configured to carry out the method as recited in claim 1.

12. The fuel cell system as recited in claim 11 wherein the fuel cell system includes a controller executing steps for calculating the recirculation ratio.
